(19) United States
(12) Patent Application Publication
(10) Pub. No.: US 2026/0246893 A1
(43) Pub. Date: Aug. 20, 2026

(54) DELAYING VIDEOTELEPHONY COMPONENTS FOR CAPTIONING

(71) Applicant: International Business Machines Corporation, Armonk, NY (US)

(72) Inventors: Guang Han Sui, Beijing (CN); Peng Hui Jiang, Beijing (CN); Jun Su, Beijing (CN); ZHI LI GUAN, Beijing (CN)

(21) Appl. No.: 19/055,344

(22) Filed: Feb. 17, 2025

(51) Int. Cl. H04N 5/278; G06F 40/58; G10L 15/00; G10L 15/30; G10L 25/57; G11B 27/00; G11B 27/031

(52) U.S. Cl. CPC H04N 5/278; G06F 40/58; G10L 15/005; G10L 15/30; G10L 25/57; G11B 27/005; G11B 27/031

(57) ABSTRACT

A system may include a memory storing program instructions. A system may include a processor in communication with the memory, the processor being configured to execute the program instructions to perform processes comprising: receiving a videotelephony feed from a first videotelephony terminal, routing the videotelephony feed through a videotelephony controller comprising a translation module and a captioning module, translating, by the translating module, communication from a language used in the videotelephony feed into a language of a second videotelephony terminal generating a translation, captioning, by captioning module, the translation onto the videotelephony feed, delaying the videotelephony feed until the translating and captioning are completed for each segment of the videotelephony feed; and displaying the delayed videotelephony feed with captions to the second videotelephony terminal.

### BACKGROUND

Videotelephony, e.g., videoconferencing or video calling, enables simultaneous two-way communication through both audio and video. Videotelephony may refer to one-on-one interactions (involving two parties or videoconferencing (typically involving group communication).

### SUMMARY

Aspects of the present disclosure relate to a computer program product, system, and method for delaying videotelephony components for captioning.

In some aspects, the techniques described herein relate to a system including: a memory storing program instructions; and a processor in communication with the memory, the processor being configured to execute the program instructions to perform processes including: receiving a videotelephony feed from a first videotelephony terminal; routing the videotelephony feed through a videotelephony controller including a translation module and a captioning module; translating, by the translating module, communication from a language used in the videotelephony feed into a language of a second videotelephony terminal generating a translation; captioning, by captioning module, the translation onto the videotelephony feed; delaying the videotelephony feed until the translating and captioning are completed for each segment of the videotelephony feed; and displaying the delayed videotelephony feed with captions to the second videotelephony terminal.

In some aspects, the techniques described herein relate to a method including: receiving a videotelephony feed from a first videotelephony terminal; routing the videotelephony feed through a videotelephony controller including a translation module and a captioning module; translating, by the translating module, communication from a language used in the videotelephony feed into a language of a second videotelephony terminal generating a translation; captioning, by captioning module, the translation onto the videotelephony feed; delaying the videotelephony feed until the translating and captioning are completed for each segment of the videotelephony feed; and displaying the delayed videotelephony feed with captions to the second videotelephony terminal.

In some aspects, the techniques described herein relate to a computer program product including one or more computer readable storage media having program instructions collectively embodied therewith, the program instructions executable by one or more processors to cause the one or more processors to perform a method, the method including: receiving a videotelephony feed from a first videotelephony terminal; routing the videotelephony feed through a videotelephony controller including a translation module and a captioning module; translating, by the translating module, communication from a language used in the videotelephony feed into a language of a second videotelephony terminal generating a translation; captioning, by captioning module, the translation onto the videotelephony feed; delaying the videotelephony feed until the translating and captioning are completed for each segment of the videotelephony feed; and displaying the delayed videotelephony feed with captions to the second videotelephony terminal.

### BRIEF DESCRIPTION OF THE DRAWINGS

The drawings included in the present application are incorporated into and form part of the specification. They illustrate embodiments of the present disclosure and, along with the description, serve to explain the principles of the disclosure. The drawings are only illustrative of certain embodiments and do not limit the disclosure.

FIG. 1 illustrates an example computing environment, according to various embodiments of the present disclosure.

FIG. 2 illustrates an example method for delaying videotelephony components for captioning, according to various embodiments of the present disclosure

FIG. 3 illustrates an example method of delaying videotelephony components for captioning, according to various embodiments of the present disclosure.

### DETAILED DESCRIPTION

Aspects of the present disclosure relate delaying videotelephony components for captioning. While the present disclosure is not necessarily limited to such applications, various aspects of the disclosure may be appreciated through a discussion of various examples using this context.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 100 contains an example of an environment for the execution of at least some of the computer code involved in performing the inventive methods, such as code for delaying videotelephony components for captioning represented by block 301 (e.g., code to enact method 300). In addition to block 301, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 301, as identified above), peripheral device set 114 (including user interface (UI), device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

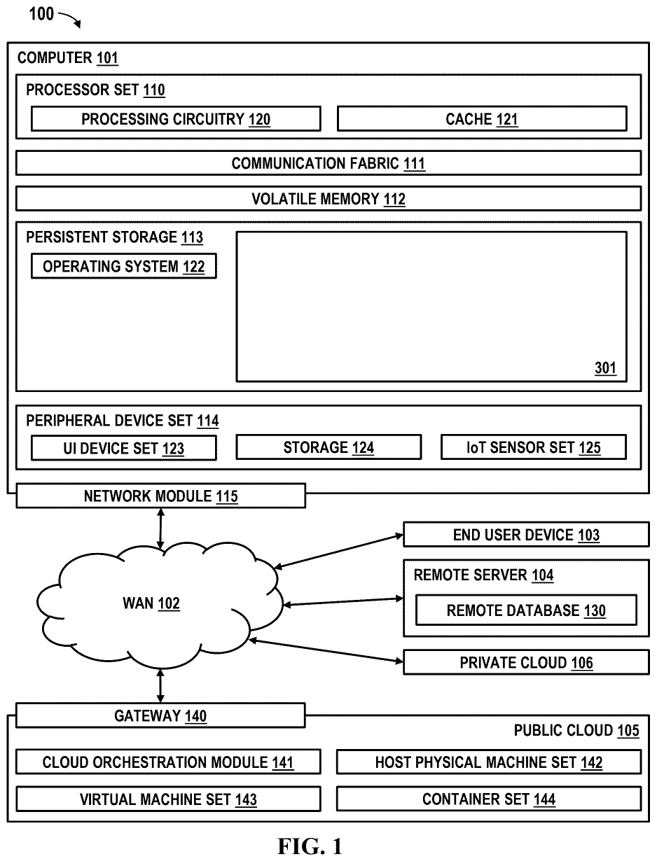

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 301 in persistent storage 113.

COMMUNICATION FABRIC 111 is the signal conduction paths that allow the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, the volatile memory is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface type operating systems that employ a kernel. The code included in block 301 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

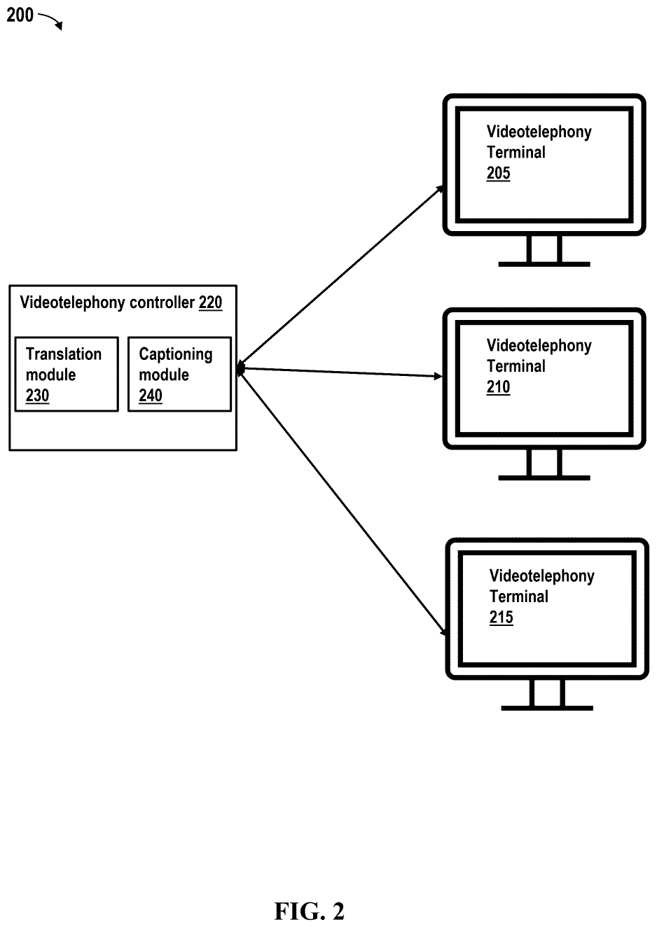

FIG. 2 depicts an example videotelephony system. The components of the videotelephony system may resemble computing environments such as the system described in FIG. 1 above.

In some embodiments, videotelephony system 200 may include one or more videotelephony terminals such as videotelephony terminals 205, 210, and/or 215. In some instances, videotelephony system 200 may have more or fewer videotelephony terminals than depicted in FIG. 2. For example, there may be 2, 10, 100, or 1000 videotelephony terminals and each may have a participant communicating in a similar or different language.

In some instances, a standalone videophone, smartphones, computers, or other multifunctional devices may be used for videotelephony terminals 205, 210, and/or 215.

In some embodiments, videotelephony system 200 may include a videotelephony controller 220. In some embodiments, videotelephony controller 220 may translate videotelephony call communication by a participant (e.g., from videotelephony terminals 205, 210, and/or 215). In some embodiments, the videotelephony call communication may be audio or visual. For example, audio communication may include spoken words, claps, snaps, laughs, or other auditory information. For example, visual communication may include sign languages such as American Sign Language, facial expressions, other gestures, and/or other mannerisms made by a participant in the video call.

In some embodiments, videotelephony controller 220 may include a translation module 230 and a captioning module 240. In some embodiments, translation module 230 may take call communication and translate a selected language for videotelephony terminals 205, 210, and/or 215. In some embodiments, translation module 230 may convert audio communication and/or visual communication into a language for a receiving videotelephony terminal. For example, translation module 230 may convert American Sign Language received from videotelephony terminal 205 to Mandarin for videotelephony terminal 215.

In some embodiments, translation module 230 may use a combination of audio communication and visual communication to translate meaning. For example, if the system records a user at videotelephony terminal 205 says “I got so much sleep last night” with a smile, the system may interpret the message as sarcasm or a joke and reflect that in a translation of the statement. In some instances, some languages may have physical expressions that have a different or opposite meaning from other languages. In some embodiments, translation module 230 may use the expression and their respective meaning in each language to augment or modify the translation. In some embodiments, the system may adjust a speed of the videotelephony feed to match with the translation, such that ideas are conveyed with a proper facial inflection. For example, facial expression may be required to deliver context into if text is a joke, serious, sarcastic, etc.

In some embodiments, translation module 230 translates the received audio communication and/or visual communication into a written representation of a language for a receiving terminal in conjunction with captioning module 240. For example, videotelephony terminal 205 records a video recording with English and American Sign Language, translation module 230 may translate the ASL and English into Mandarin and captioning module 240 may generate text in Mandarin from the translation to display for receiving videotelephony terminal 210. In some embodiments, a receiving terminal may have a different selected language from the language that a user of the receiving terminal converses in. For example, a user of videotelephony terminal 205 may be communicating in American Sign Language (ASL), but since ASL does not have a written form of its own, the system may display captioning in English.

In some embodiments, the captioning may be displayed without the video. In some embodiments, enabling, based on a prompting by a second user on the second videotelephony terminal, a listen only mode; and displaying, based on the enabling, the captions without a video component of the videotelephony feed. In some instances, this mode may allow a user to focus on the spoken words and captions.

In some embodiments, the video and audio may be sped up to real time when there is a pause in the speech of a speaker, or when a user of a receiving videotelephony terminal speaks. In some embodiments, speeding up the video may either play a video at an accelerated rate (e.g., 4× fast forwarding) or simply skip any pauses in the conversing. In some instances, the system may only fast forward when there is a pause in the conversing (talking, signing, gesturing, etc). In some instances, the system may fast forward even when a speaker is actively speaking.

In some embodiments, when speakers of two terminals are conversing at the same time each may continue to play a delayed captioned video and only speed up the video to real time when a speaker of each respective video pauses. For example, if speakers of 2 terminals are speaking at the same time there may not be an opportunity to catch the respective captioned videos up to real time until each respective speaker pauses their conversation.

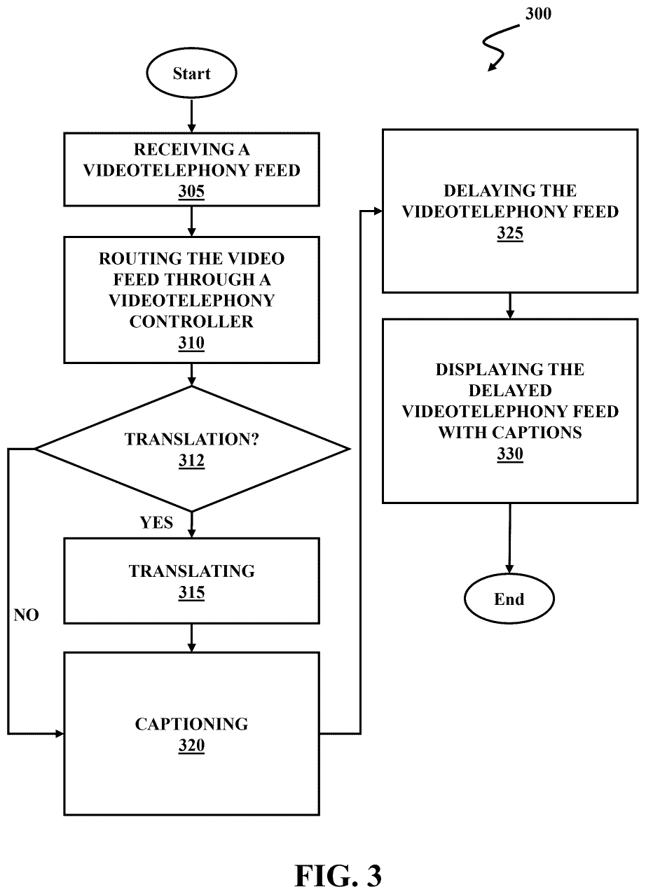

FIG. 3 depicts an example method 300 for delaying videotelephony components for captioning. Operations of method 300 may be enacted by one or more computing environments such as the system described in FIG. 1 above.

Method 300 begins with operation 305 of receiving a videotelephony feed from a first videotelephony terminal. In some embodiments, the video chat feed may have a video component and/or an audio component.

Method 300 continues with operation 310 of routing the videotelephony feed through a videotelephony controller comprising a translation module and a captioning module. In some embodiments, the videotelephony controller may be part of the first videotelephony terminal, another videotelephony terminal, a component on a cloud system, or another computer system. In some embodiments, there may be multiple instances of the videotelephony controller. For example, there may be a videotelephony controller for each videotelephony terminal or for a group of receiving terminals. In some instances, the terminals may be grouped by controlling organizations, language of the receiving terminals, or other methods.

Method 300 continues with operation 312 of determining if a translation is needed. In some embodiments, when a sending videotelephony terminal is conversing in a language that a receiving videotelephony terminal user indicates they are fluent in, a translation may not be needed. In some embodiments, when the conversing language, for example ASL where there is not a written language, a translation may be needed to caption a videotelephony feed even if the receiving videotelephony terminal user is fluent in ASL. If a translation is needed, method 300 moves to operation 315. If a translation is not needed, method 300 moves to operation 320.

Method 300 continues with operation 315 of translating, by the translating module, communication from a language used in the videotelephony feed into a language of a second videotelephony terminal generating a translation. In some embodiments, each videotelephony may have a language setting dictating what language the communication should be translated into. For example, a terminal may prompt a user for one or more languages the user is fluent in. In some instances, the terminal may prompt a user for a default language and fluent languages. For example, the captioning module may use the default language for situations where the user is not fluent in a language used for communication and the language used to communicate where the user is fluent in the language used for communication. In some embodiments, the videotelephony controller may detect languages a user speaks in to determine what language to translate a conversation into. In some instances, translation may not be necessary, thus operation 315 may skipped.

Method 300 continues with operation 320 of captioning, by captioning module, the translation onto the videotelephony feed. In some instances, a captioning module may transcribe the translation into a graphical form, refereed to as text herein, but also includes, graphics, characters, glyphs, symbols, pictograms, etc. In some embodiments, the captioning module may transpose the text onto the videotelephony feed or another feed. For example, the captioning module may print the text at the bottom of the videotelephony feed, word bubbles by the image of the conversing user, or other places on the videotelephony feed.

Method 300 continues with operation 325 of delaying the videotelephony feed until the translating and/or the captioning are completed for each segment of the videotelephony feed. In some embodiments, the captioning and translation takes an amount of time. In order to have the captioning match the videotelephony feed, the videotelephony feed may need to be delayed until the captioning module finishes the captioning. For example, if captioning takes 10 seconds, the system may delay the videotelephony feed for 10 seconds so the captioning is displayed with the proper segments of a video recording. In some embodiments, the system may dissect a video component of the videotelephony feed into segments for each word, phrase, gesture, sign, or utterance communicated by the first user; and reorder segments of the video such that translated words and corresponding video component segments are matched. For example, different languages may have different syntax. In some embodiment, portions of a video may need to be rearranges such the syntax of the translated caption matches the facial expressions.

Method 300 continues with operation 330 of displaying the delayed videotelephony feed with captions to the second videotelephony terminal. In some embodiments, the videotelephony terminal may use a screen, a hologram, a projection, virtual reality goggles, or other methods of displaying a videotelephony meeting.

In some embodiments, method 300 may be repeated for each videotelephony terminal or for disparate groups of videotelephony terminals. For example, the same captioned feed may be used for all users with English fluency, but a different feed may need to be used for users with Swahili fluency.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present disclosure have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to explain the principles of the embodiments, the practical application or technical improvement over technologies found in the marketplace, or to enable others of ordinary skill in the art to understand the embodiments disclosed herein.

What is claimed is:

1. A system comprising:
a memory storing program instructions; and
a processor in communication with the memory, the processor being configured to execute the program instructions to perform processes comprising:
receiving a videotelephony feed from a first videotelephony terminal;
routing the videotelephony feed through a videotelephony controller comprising a translation module and a captioning module;
translating, by the translating module, communication from a language used in the videotelephony feed into a language of a second videotelephony terminal generating a translation;
captioning, by captioning module, the translation onto the videotelephony feed;
delaying the videotelephony feed until the translating and captioning are completed for each segment of the videotelephony feed; and
displaying the delayed videotelephony feed with captions to the second videotelephony terminal.

2. The system of claim 1, wherein the memory stores further program instructions, and wherein the processor is configured to execute the further program instructions to perform the processes further comprising:
fast forwarding the videotelephony feed to real time during a pause in communication in the videotelephony feed.

3. The system of claim 1, wherein the memory stores further program instructions, and wherein the processor is configured to execute the further program instructions to perform the processes further comprising:
determining a language that user of the first terminal is conversing in;
determining a default language for a user of the second terminal; and
determining one or more fluent languages for the user of the second terminal.

4. The system of claim 1, wherein the memory stores further program instructions, and wherein the processor is configured to execute the further program instructions to perform the processes further comprising:
enabling, based on a prompting by a second user on the second videotelephony terminal, a listen only mode; and
displaying, based on the enabling, the captions without a video component of the videotelephony feed.

5. The system of claim 1, wherein a first user of the first videotelephony terminal is communicating in sign language and the videotelephony feed is delayed to match the captioning with the sign language.

6. The system of claim 5, wherein the memory stores further program instructions, and wherein the processor is configured to execute the further program instructions to perform the processes further comprising:
adjusting a speed of the videotelephony feed to match with the translation, such that ideas are conveyed with a proper facial inflection.

7. The system of claim 6, wherein the memory stores further program instructions, and wherein the processor is configured to execute the further program instructions to perform the processes further comprising:
dissecting a video component of the videotelephony feed into segments for each word communicated by the first user; and
reordering segments of the video such that translated words and corresponding video component segments are matched.

8. A method comprising:
receiving a videotelephony feed from a first videotelephony terminal;
routing the videotelephony feed through a videotelephony controller comprising a translation module and a captioning module;
translating, by the translating module, communication from a language used in the videotelephony feed into a language of a second videotelephony terminal generating a translation;
captioning, by captioning module, the translation onto the videotelephony feed;
delaying the videotelephony feed until the translating and captioning are completed for each segment of the videotelephony feed; and
displaying the delayed videotelephony feed with captions to the second videotelephony terminal.

9. The method of claim 8, further comprising:
fast forwarding the videotelephony feed to real time during a pause in communication in the videotelephony feed.

10. The method of claim 8, further comprising:
determining a language that user of the first terminal is conversing in;
determining a default language for a user of the second terminal; and
determining one or more fluent languages for the user of the second terminal.

11. The method of claim 8, further comprising:
enabling, based on a prompting by a second user on the second videotelephony terminal, a listen only mode; and
displaying, based on the enabling, the captions without a video component of the videotelephony feed.

12. The method of claim 8, wherein a first user of the first videotelephony terminal is communicating in sign language and the videotelephony feed is delayed to match the captioning with the sign language.

13. The method of claim 12, further comprising:
adjusting a speed of the videotelephony feed to match with the translation, such that ideas are conveyed with a proper facial inflection.

14. The method of claim 13, further comprising:
dissecting a video component of the videotelephony feed into segments for each word communicated by the first user; and
reordering segments of the video such that translated words and corresponding video component segments are matched.

15. A computer program product comprising one or more computer readable storage media having program instructions collectively embodied therewith, the program instructions executable by one or more processors to cause the one or more processors to perform a method, the method comprising:
receiving a videotelephony feed from a first videotelephony terminal;
routing the videotelephony feed through a videotelephony controller comprising a translation module and a captioning module;
translating, by the translating module, communication from a language used in the videotelephony feed into a language of a second videotelephony terminal generating a translation;
captioning, by captioning module, the translation onto the videotelephony feed;
delaying the videotelephony feed until the translating and captioning are completed for each segment of the videotelephony feed; and
displaying the delayed videotelephony feed with captions to the second videotelephony terminal.

16. The computer program product of claim 15, further comprising additional program instructions collectively stored on the one or more computer readable storage media and configured to cause the one or more processors to perform the method further comprising:
fast forwarding the videotelephony feed to real time during a pause in communication in the videotelephony feed.

17. The computer program product of claim 15, further comprising additional program instructions collectively stored on the one or more computer readable storage media and configured to cause the one or more processors to perform the method further comprising:
determining a language that user of the first terminal is conversing in;
determining a default language for a user of the second terminal; and
determining one or more fluent languages for the user of the second terminal.

18. The computer program product of claim 15, further comprising additional program instructions collectively stored on the one or more computer readable storage media and configured to cause the one or more processors to perform the method further comprising:
enabling, based on a prompting by a second user on the second videotelephony terminal, a listen only mode; and
displaying, based on the enabling, the captions without a video component of the videotelephony feed.

19. The computer program product of claim 15, wherein a first user of the first videotelephony terminal is communicating in sign language and the videotelephony feed is delayed to match the captioning with the sign language.

20. The computer program product of claim 19, further comprising additional program instructions collectively stored on the one or more computer readable storage media and configured to cause the one or more processors to perform the method further comprising:
adjusting a speed of the videotelephony feed to match with the translation, such that ideas are conveyed with a proper facial inflection.
